(19) United States
(12) Patent Application Publication
(10) Pub. No.: US 2016/0342254 A1
(43) Pub. Date: Nov. 24, 2016

(54) Ultraviolet-Curable Adhesive Composition For Touch Panel, Optical Member Producing Method Using Same, Cured Product, And Touch Panel

(71) Applicant: NIPPON KAYAKU KABUSHIKI KAISHA, Tokyo (JP)

(72) Inventors: Hayato Motohashi, Tokyo (JP); Takafumi Mizuguchi, Tokyo (JP); Hideaki Kametani, Tokyo (JP)

(21) Appl. No.: 15/116,606

(22) PCT Filed: Feb. 6, 2015
(86) PCT No.: PCT/JP2015/053380

§ 371 Date: Aug. 4, 2016

(30) Foreign Application Priority Data
Feb. 10, 2014 (JP) 2014-023116

(51) Int. Cl. G06F 3/041; B32B 37/06; B32B 37/12; C09J 4/00; C09J 115/00

(52) U.S. Cl. CPC G06F 3/0412; C09J 4/00; C09J 115/00; B32B 37/12; B32B 37/06; G06F 2203/04103; B32B 2307/40; B32B 2310/0831

(57) ABSTRACT

Provided herein is an ultraviolet-curable adhesive composition that causes little damage to an optical base material, and with which an optical member can be obtained with desirable curability and adhesion and good productivity while achieving high whitening resistance, and improving bonding strength even when an optical base material is laminated after the ultraviolet irradiation of the coating layer formed by applying the ultraviolet-curable adhesive composition to the optical base material. An optical member producing method using the composition is also provided. The composition contains a monofunctional acrylate (A) represented by the following formula (1), a photopolymerizable oligomer (B), a photopolymerizable monomer (C) other than (A), and a photopolymerization initiator (D), wherein R₁ represents a hydrogen atom or the like, and n represents an integer of 1 to 3.

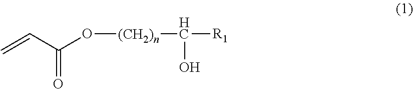

### TECHNICAL FIELD

The present invention relates to an ultraviolet-curable adhesive composition for laminating at least two optical base materials, and to a method for producing an optical member using the composition, among others.

### BACKGROUND ART

There has been increasing use of display devices that enable input through a touch panel attached to the display screen of display devices, such as in liquid crystal displays, plasma displays, and organic EL displays. Such touch panel is structured to include glass plates or resin-made films having transparent electrodes formed thereon, and a glass- or resin-made transparent protective plate optionally laminated to the touch screen surface of the glass plates or resin-made films that are laminated face to face with a small gap in between.

A technique that uses a double-sided adhesive sheet is available for the lamination of glass plates or films having transparent electrodes formed thereon and a glass- or resin-made transparent protective plate in a touch panel, or for the lamination of a touch panel and a display unit. A problem of using a double-sided adhesive sheet, however, is that it easily traps bubbles. As an alternative to the double-sided adhesive sheet, a technique is proposed that uses a flexible ultraviolet-curable adhesive composition for lamination.

On the other hand, a problem occurs when a touch panel and a display unit are laminated to each other with an ultraviolet-curable adhesive in that the adhesive layer turns white upon a change occurring in the environment from a high-temperature high-humidity environment to room temperature. In the transparent protective plate, a stripe-like light-shielding portion is formed at the outermost edge to improve the contrast of a displayed image. When the transparent protective plate with such a light-shielding portion is laminated using an ultraviolet-curable adhesive composition, ultraviolet rays cannot sufficiently reach the areas of ultraviolet curable resin shaded by the light-shielding portion, and fail to sufficiently cure the resin. Insufficient curing of the resin causes problems, including uneven display in the vicinity of the light-shielding portion.

A technique to prevent hygrothermal whitening is disclosed in PTL 1, in which a polyurethane compound, and a (meth)acrylic acid ester having a hydroxyl group are incorporated in an ultraviolet-curable resin composition for transparent adhesive sheets to prevent whitening. However, the transparent adhesive sheet involves the bubble trapping problem in the lamination, as noted above. Another problem is poor whitening resistance. Specifically, when the resin cured product is between low permeable members such as glass, the film turns white upon a change occurring in the environment from a high-temperature high-humidity environment to room temperature, due to factors such as bubbles, and moisture absorption by the cured film.

A technique to improve resin curing in light shielded areas is disclosed in PTL 2, in which organic peroxide is incorporated in an ultraviolet curable resin, and the resin in the light shielded portions is cured by heating after ultraviolet irradiation. However, there is a concern that the heating process may be damaging to a liquid crystal display device or the like. The technique is also problematic in terms of productivity because it typically requires at least 60 minutes of heating process to bring the resin to a sufficiently cured state. PTL 3 discloses a technique in which the resin in the light shielded portion is cured by applying ultraviolet rays from the outer side-surface side of surfaces forming the light-shielding portion. However, the method is limiting in that ultraviolet application from side surfaces is difficult to achieve in some shapes of liquid crystal display devices. PTL 4 discloses a technique that takes advantage of the slow acting of a cationic polymerizable ultraviolet curable resin. However, the technique suffers from the poor flexibility of the cured resin.

PTL 5 proposes a technique to sufficiently cure resin in the light shielded portion solely by photo-polymerization. A problem, however, is that the bonding strength of an optical member suffers when ultraviolet rays are applied to a laminated optical base member after the ultraviolet irradiation of the coating layer formed by applying an ultraviolet-curable resin composition to the optical base member.

### BACKGROUND ART

### Citation List

### Patent Literature

[PTL 1] JP-A-2013-242724

[PTL 2] Japanese Patent No. 4711354

[PTL 3] JP-A-2009-186954

[PTL 4] JP-A-2010-248387

[PTL 5] Japanese Patent No. 5138820

### SUMMARY OF INVENTION

### Technical Problem

It is an object of the present invention to provide an ultraviolet-curable adhesive composition that causes little damage to an optical base material, and with which a display unit and other such optical members can be obtained with desirable curability and adhesion and good productivity while achieving high whitening resistance, and improving bonding strength even when an optical base material is laminated after the ultraviolet irradiation of the coating layer formed by applying the ultraviolet-curable adhesive composition to the optical base material. The present invention is also intended to provide an optical member producing method using the composition, a cured product, and a touch panel.

### Solution to Problem

The present inventors completed the present invention after the intensive studies conducted to solve the foregoing problems. Specifically, the present invention is concerned with the following (1) to (18).

(1) An ultraviolet-curable adhesive composition for touch panels, the composition being a resin composition for use in the lamination of at least two optical base materials, and comprising a monofunctional acrylate (A) represented by the following formula (1), a photopolymerizable oligomer (B), a photopolymerizable monomer (C) other than (A), and a photopolymerization initiator (D),

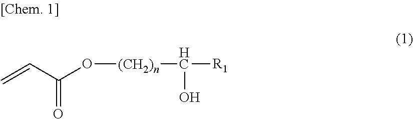

wherein R₁ represents a hydrogen atom or CH₃, and n represents an integer of 1 to 3.
(2) The ultraviolet-curable adhesive composition for touch panels as described in (1) above, wherein the (A) component is contained in the ultraviolet curable composition in an amount of 2 mass % or more.
(3) The ultraviolet-curable adhesive composition for touch panels as described in (1) or (2) above, wherein the photopolymerizable oligomer (B) is a urethane (meth)acrylate.
(4) The ultraviolet-curable adhesive composition for touch panels as described in (3) above, wherein the photopolymerizable oligomer (B) is a urethane (meth)acrylate having at least one skeleton selected from the group consisting of polypropylene, polybutadiene, hydrogenated polybutadiene, polyisoprene, and hydrogenated polyisoprene.
(5) The ultraviolet-curable adhesive composition for touch panels as described in any one of (1) to (4) above, wherein the monofunctional acrylate (A) is represented by the following formula (2),

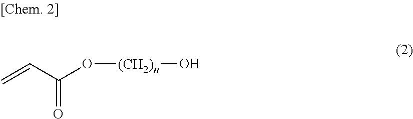

wherein a represents an integer of 2 to 4.
(6) The ultraviolet-curable adhesive composition for touch panels as described in any one of (1) to (5) above, wherein the (A) component is 4-hydroxybutyl acrylate.
(7) The ultraviolet-curable adhesive composition for touch panels as described in any one of (1) to (6) above, which further comprises a softening component (E).
(8) The ultraviolet-curable adhesive composition for touch panels as described in (7) above, which contains a hydroxyl group-containing polymer, and/or a liquid terpene-based resin as the softening component (E).
(9) The ultraviolet-curable adhesive composition for touch panels as described in any one of (1) to (8) above, which comprises a monofunctional acrylate represented by the following formula (3) as the (C) component,

[Chem. 3]

X—O—R₂ (3)

wherein X represents an acryloyl group, and R₂ represents an alkyl group of 10 to 20 carbon atoms.
(10) The ultraviolet-curable adhesive composition for touch panels as described in any one of (1) to (8) above, which comprises a monofunctional acrylate represented by the following formula (4) as the (C) component,

[Chem. 4]

X—O—R₃ (4)

wherein X represents an acryloyl group, and R₃ represents an alkyl group of 12 to 18 carbon atoms.
(11) The ultraviolet-curable adhesive composition for touch panels as described in any one of (1) to (8) above, which comprises isostearyl acrylate as the (C) component.
(12) A method for producing an optical member that includes at least two optical base materials that are laminated to each other,

the method comprising the steps of:

1) applying the ultraviolet-curable adhesive composition for touch panels of any one of (1) to (11) above to at least one optical base material to form a coating layer, and irradiating the coating layer with ultraviolet light to obtain an optical base material having a cured product layer; and

2) laminating another optical base material, or the cured product layer of another optical base material obtained in the step 1) to the cured product layer of the optical base material obtained in the step 1).

(13) The method as described in (12) above, wherein the cured product layer obtained in the step 1) includes a cured portion and an uncured portion, the cured portion being a portion that is present on the optical base material side, and the uncured portion being a portion that is present opposite the optical base material side.
(14) The method as described in (13) above, further comprising the step 3) of curing the cured product layer by applying ultraviolet light to the cured product layer having the uncured portion in the laminated optical base material, the step 3) being performed after the steps 1) and 2).
(15) The method as described in any one of (12) to (14) above, wherein the ultraviolet light applied to the ultraviolet-curable adhesive composition in the step 1) has a maximum illuminance ratio of 30 or less in a 200 to 320 nm wavelength range relative to the maximum illuminance of 100 taken in a wavelength range of 320 nm to 450 nm.
(16) The method as described in any one of (12) to (14) above, wherein the ultraviolet light applied to the ultraviolet-curable adhesive composition in the step 1) has a maximum illuminance ratio of 10 or less in a 200 to 320 nm wavelength range relative to the maximum illuminance of 100 taken in a wavelength range of 320 nm to 450 nm.
(17) A cured product obtained by irradiating the ultraviolet-curable adhesive of any one of (1) to (11) above with an active energy ray.
(18) A touch panel using the ultraviolet-curable adhesive of any one of (1) to (11) above.

### BRIEF DESCRIPTION OF DRAWINGS

FIG. 1 is a step diagram representing First Embodiment of a producing method of the present invention.

FIG. 2 is a step diagram representing Second Embodiment of the producing method of the present invention.

FIG. 3 is a step diagram representing Third Embodiment of the producing method of the present invention.

FIG. 4 is a schematic diagram representing an optical member obtained by using the present invention.

### DESCRIPTION OF EMBODIMENTS

An ultraviolet-curable adhesive composition of the present invention is described below.

An ultraviolet-curable adhesive composition for touch panels of the present invention is a resin composition for use in the lamination of at least two optical base materials, and contains a monofunctional acrylate (A) represented by the following formula (1), a photopolymerizable oligomer (B), a photopolymerizable monomer (C) other than (A), and a photopolymerization initiator (D).

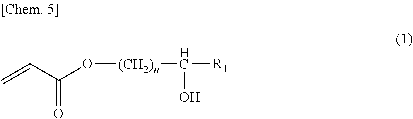

(In the formula, R₁ represents a hydrogen atom or CH₃, and n represents an integer of 1 to 3.) The ultraviolet-curable adhesive composition also may optionally contain other components that are addable to ultraviolet-curable adhesive compositions used for optical applications.

As used herein, “addable to ultraviolet-curable adhesive compositions used for optical applications” means containing no additives that lower the transparency of the cured product as to make the product unusable for optical applications.

When the ultraviolet-curable resin composition used in the present invention is cured to produce a sheet that has a thickness of 200 μm upon curing, the sheet has an average transmittance of preferably at least 90% for light of 400 to 800 nm wavelengths.

The ultraviolet-curable resin composition preferably contains 1 to 20 weight % of the monofunctional acrylate (A) represented by the formula (1), 5 to 90 weight % of the photopolymerizable oligomer (B), 5 to 90 weight % of the photopolymerizable monomer (C) other than (A), and 0.1 to S weight % of the photopolymerization initiator (D), with other components accounting for the remainder.

The photopolymerization initiator (D) contained in the ultraviolet-curable resin composition of the present invention may be any of photopolymerization initiators typically used.

Examples of the monofunctional acrylate (A) represented by the formula (1) in the ultraviolet-curable adhesive composition of the present invention include 4-hydroxybutyl acrylate, 2-hydroxypropyl acrylate, 3-hydroxypropyl acrylate, and 2-hydroxyethyl acrylate, and these may be used in a combination of two or more, as required. Here, when n is 2 or less (particularly when n is 1 or less) in the formula (1), R₁ is preferably a methyl group. When n is 3 or more, R₁ is preferably a hydrogen atom. The total number of carbon atoms in the formula (1) is preferably 2 or more because it makes it possible to obtain a less volatile and less clouded resin composition. Amongst that, a monofunctional acrylate represented by the following formula (2) is preferable from the viewpoints of bonding strength and whitening resistance.

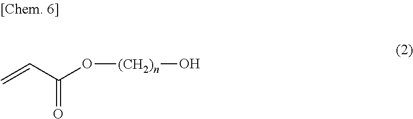

(In the formula, n represents an integer of 2 to 4.) Examples of the monofunctional acrylate represented by the formula (2) include 4-hydroxybutyl acrylate, 3-hydroxypropyl acrylate, and 2-hydroxyethyl acrylate. 4-Hydroxybutyl acrylate is particularly preferred from the viewpoint of low volatility. Use of (meth)acrylate-based resins is not desirable as it tends to slow the cure rate, and increases the cure time when the adhesive composition is actually used. As used herein, “(meth)acrylate” means (meth)acrylate or acrylate, or both. The same is the case for “(meth)acrylic acid”. “Acrylates” means only acrylates, and excludes (meth)acrylates.

In the compound represented by the formula (1), MOH/(MC+MB) is preferably 0.3 or less, more preferably 0.28 or less, particularly preferably 0.25 or less, where MC is the total number of carbon atoms excluding the acryloyl group, MOH is the number of OH groups, and MB is the number of carbon branched chains. The compound can have certain levels of molecular weight, and volatility and cloudiness can be reduced by satisfying these ranges. It is also advantageous to satisfy these ranges in terms of preventing whitening due to the hydroxyl group. The monofunctional acrylate (A) represented by the formula (1) satisfying this condition will be referred to as “low-volatile and whitening-resistant acrylate.”

The content of the (A) component is preferably 1 to 20 weight %, more preferably 2 to 10 weight %, particularly preferably 5.5 to 8 weight %. Whitening resistance may suffer when the content of the (A) component is less than 1%. On the other hand, a content exceeding 20 weight % may facilitate bubble entry during lamination, or may cloud the liquid as the compatibility with other components deteriorates.

In the present invention, it is not preferable to incorporate a hydroxyl group-containing methacrylate in the ultraviolet-curable adhesive composition because it may slow the cure rate, or adversely affect physical properties such as whitening resistance. When containing a methacrylate having a hydroxyl group, the content thereof is preferably 10 weight % or less, particularly preferably 5 weight % or less.

The photopolymerizable oligomer (B) in the ultraviolet-curable adhesive composition of the present invention is not particularly limited. Preferably, the photopolymerizable oligomer (B) is one selected from the group consisting of urethane (meth)acrylates, (meth)acrylates having a polyisoprene or hydrogenated polyisoprene skeleton, and (meth)acrylates having a polybutadiene or hydrogenated polybutadiene skeleton. Among them, urethane (meth)acrylates are preferred from the viewpoint of bonding strength, and urethane (meth)acrylates having at least one skeleton selected from the group consisting of polybutadiene, hydrogenated polybutadiene, polyisoprene, and hydrogenated polyisoprene are more preferred from the viewpoint of moisture resistance.

The urethane (meth)acrylates are obtained through the reaction of a polyhydric alcohol, a polyisocyanate, and a hydroxyl group-containing (meth)acrylate.

Examples of the polyhydric alcohol include alkylene glycols of 1 to 10 carbon atoms, such as polybutadiene glycol, hydrogenated polybutadiene glycol, polyisoprene glycol, hydrogenated polyisoprene glycol, neopentyl glycol, 3-methyl-1, 5-pentanediol, ethylene glycol, propylene glycol, 1,4-butanediol, and 1, 6-hexanediol; triols such as trimethylolpropane, and pentaerythritol; alcohols having a cyclic skeleton, such as tricyclodecane dimethylol, and bis-[hydroxymethyl]-cyclohexane; polyester polyols obtained through the reaction of polyhydric alcohols such as above and polybasic acids (for example, such as succinic acid, phthalic acid, a hexahydrophthalic anhydride, terephthalic acid, adipic acid, azelaic acid, and a tetrahydrophthalic anhydride); caprolactone alcohols obtained through the reaction of a polyhydric alcohol and ε-caprolactone; polycarbonate polyols (for example, such as a polycarbonate diol obtained through the reaction of 1,6-hexanediol and diphenyl carbonate); and polyether polyols (for example, such as polyethylene glycol, polypropylene glycol, polytetramethylene glycol, and ethylene oxide-modified bisphenol A). From the viewpoints of bonding strength and moisture resistance, preferred as the polyhydric alcohols are propylene glycol, polybutadiene glycol, hydrogenated polybutadiene glycol, polyisoprene glycol, and hydrogenated polyisoprene glycol. Particularly preferred from the viewpoints of transparency and flexibility are propylene glycol, hydrogenated polybutadiene glycol, and hydrogenated polyisoprene glycol having a weight-average molecular weight of 2,000 or more. Hydrogenated polybutadiene glycol is preferred from the viewpoints of discoloration such as heat-resisting colorability, and compatibility. Here, the upper limit of weight-average molecular weight is preferably 10,000 or less, more preferably 5,000 or less, though it is not particularly limited. Two or more polyhydric alcohols may be used in combination, as required.

Examples of the organic polyisocyanate include isophorone diisocyanate, hexamethylene diisocyanate, tolylene diisocyanate, xylene diisocyanate, diphenylmethane-4,4′-diisocyanate, and dicyclopentanyl isocyanate. Isophorone diisocyanate is preferred from the viewpoint of tenacity.

Examples of the hydroxyl group-containing (meth)acrylates include hydroxy C2 to C4 alkyl (meth)acrylates such as hydroxyethyl (meth)acrylate, hydroxypropyl (meth)acrylate, and hydroxybutyl (meth)acrylate; dimethylolcyclohexyl mono(meth)acrylates, hydroxycaprolactone (meth)acrylates, and polyalkylene glycol (meth)acrylates terminated with a hydroxyl group.

The reaction for obtaining the urethane (meth)acrylates is performed, for example, as follows. Specifically, an organic polyisocyanate is mixed with a polyhydric alcohol such that the isocyanate group is preferably 1.1 to 2.0 equivalents, further preferably 1.1 to 1.5 equivalents per equivalent of the hydroxyl group of the polyhydric alcohol, and these are allowed to react at a reaction temperature of preferably 70 to 90° C. to synthesize a urethane oligomer. This is followed by mixing a hydroxy(meth)acrylate compound with the urethane oligomer such that the hydroxyl group is preferably 1 to 1.5 equivalents per equivalent of the isocyanate group of the urethane oligomer, and reacting these at 70 to 90° C. to give a urethane (meth)acrylate of interest.

The weight-average molecular weight of the methane (meth)acrylate is preferably about 7,000 to 100,000, more preferably 10,000 to 60,000. Large shrinkage occurs when the weight-average molecular weight is less than 7,000, whereas curability suffers when the weight-average molecular weight is above 100,000.

In the ultraviolet-curable adhesive composition of the present invention, one or more urethane (meth)acrylates may be used by being mixed in any proportions. The weight proportion of the urethane (meth)acrylate in the photo-curable transparent adhesive composition of the present invention is typically 5 to 90 weight %, preferably to 50 weight %.

The (meth)acrylates having a polyisoprene skeleton has a (meth)acryloyl group at the terminal or on the side chain of the polyisoprene molecule. The (meth)acrylates having a polyisoprene skeleton are available as “UC-203” (manufactured by Kuraray). The (meth)acrylates having a polyisoprene skeleton has a number average molecular weight of preferably 1,000 to 50,000, more preferably about 25,000 to 45,000 in terms of a polystyrene.

The weight proportion of the (meth)acrylate having a polyisoprene skeleton in the photo-curable transparent adhesive composition of the present invention is typically to 90 weight %, preferably 10 to 50 weight %.

As the photopolymerizable monomer (C) other than (A), a (meth)acrylate having preferably one (meth)acryloyl group within the molecule may be used. In this case, the photopolymerizable monomer (C) represents (meth)acrylates other than urethane (meth)acrylates, (meth)acrylates having a polyisoprene or hydrogenated polyisoprene skeleton, and (meth)acrylates having a polybutadiene or hydrogenated polybutadiene skeleton.

Specific examples of (meth)acrylates having one (meth)acryloyl group within the molecule include alkyl (meth)acrylates of 5 to 25 carbon atoms, such as isooctyl (meth)acrylate, isoamyl (meth)acrylate, lauryl (meth)acrylate, isodecyl (meth)acrylate, stearyl (meth)acrylate, cetyl (meth)acrylate, isomyristyl (meth)acrylate, isostearyl (meth)acrylate, and tridecyl (meth)acrylate; (meth)acrylates having a cyclic skeleton, such as benzyl (meth)acrylate, tetrahydrofurfuryl (meth)acrylate, acryloylmorpholine, phenylglycidyl (meth)acrylate, tricyclodecane(meth)acrylate, dicyclopentenyl acrylate, dicyclopentenyloxyethyl (meth)acrylate, isobornyl (meth)acrylate, dicyclopentanyl (meth)acrylate, 1-adamantyl acrylate, 2-methyl-2-adamantyl acrylate, 2-ethyl-2-adamantyl acrylate, 1-adamantyl methacrylate, polypropylene oxide-modified nonylphenyl (meth)acrylate, and dicyclopentadieneoxyethyl (meth)acrylate; alkyl (meth)acrylates of 5 to 7 carbon atoms having a hydroxyl group; polyalkylene glycol (meth)acrylates such as ethoxydiethylene glycol (meth)acrylate, polypropylene glycol (meth)acrylate, polypropylene oxide-modified nonylphenyl (meth)acrylate; ethylene oxide-modified phenoxylated phosphoryl (meth)acrylate, ethylene oxide-modified butoxylated phosphoryl (meth)acrylate, ethylene oxide-modified octyloxylated phosphoryl (meth)acrylate, and caprolactone-modified tetrafurfuryl (meth)acrylate.

From the viewpoints of flexibility and reactivity, monofunctional acrylates represented by the following formula (3) are preferable.

[Chem. 7]

X—O—R₂ (3)

(In the formula, X represents an acryloyl group, and R₂ represents an alkyl group of 10 to 20 carbon atoms.)

From the viewpoint of bonding strength, monofunctional acrylates represented by the following formula (4) are further preferred.

[Chem. 8]

X—O—R₃ (4)

(In the formula, X represents an acryloyl group, and R₃ represents an alkyl group of 12 to 18 carbon atoms.)

Isostearyl acrylate is even more preferable from the viewpoints of low volatility and reactivity, and flexibility.

From the viewpoint of improving compatibility while avoiding clouding of the resin composition itself and ensuring transparency, it is preferable that MR, MC, and MB have a certain ratio, where MR is the number of alkyl groups represented by R₂ in the formula (3), MC is the total number of carbon atoms excluding the acryloyl group in the compounds represented by the formula (1), and MB is the number of carbon branched chains in the compounds represented by the formula (1). Specifically, the resin composition is preferably one containing the both compounds with the MR/(MC+MB) ratio (hereinafter, simply “specific ratio”) of 5.5 or less, particularly preferably 5 or less. From the viewpoint of providing particularly desirable whitening resistance, the resin composition is preferably one containing the low-volatile and whitening-resistant acrylates, with the both compounds satisfying the specific ratio of 5.5 or less, particularly preferably 5 or less.

The composition of the present invention may contain (meth)acrylates other than the (meth)acrylates having one (meth)acryloyl group within the molecule, provided that it is not detrimental to the characteristics of the present invention. Examples of such (meth)acrylates include tricyclodecane dimethylol di(meth)acrylate, dioxane glycol di(meth)acrylate, polypropylene glycol di(meth)acrylate, polytetramethylene glycol di(meth)acrylate, alkylene oxide modified bisphenol A type di(meth)acrylate, caprolactone modified hydroxypivalic acid neopentyl glycol di(meth)acrylate, and ethylene oxide-modified phosphoric acid di(meth)acrylate, trimethylol C2 to C10 alkane tri(meth)acrylates (such as trimethylolpropane tri(meth)acrylate, and trimethyloloctane tri(meth)acrylate), trimethylol C2 to C10 alkane polyalkoxy tri(meth)acrylates (such as trimethylolpropane polyethoxy tri(meth)acrylate, trimethylolpropane polypropoxy tri(meth)acrylate, and trimethylolpropane polyethoxypolypropoxy tri(meth)acrylate), tris[(meth)acryloyloxyethyl] isocyanurate, pentaerythritol tri(meth)acrylate, alkylene oxide modified trimethylolpropane tri(meth)acrylates (such as ethylene oxide modified trimethylolpropane tri(meth)acrylate, and propylene oxide modified trimethylolpropane tri(meth)acrylate), pentaerythritol polyethoxy tetra(meth)acrylate, pentaerythritol polypropoxy tetra(meth)acrylate, pentaerythritol tetra(meth)acrylate, ditrimethylolpropane tetra(meth)acrylate, dipentaerythritol tetra(meth)acrylate, dipentacrythritol penta(meth)acrylate, and dipentaerythritol hexa(meth)acrylate.

When using these compounds in combination, it is preferable in the present invention to use monofunctional or bifunctional (meth)acrylates to inhibit cure shrinkage.

In the ultraviolet-curable adhesive composition of the present invention, the (meth)acrylate monomer components may be used by mixing one or more of these components in any proportions. The weight proportion of the photopolymerizable monomer (C) other than (A) in the photo-curable transparent adhesive composition of the present invention is typically 5 to 90 weight %, preferably 10 to 50 weight %. Curability suffers when the weight proportion is less than 5 weight %, whereas shrinkage increases with a weight proportion above 90 weight %.

The total content of the (A) component, the (B) component, and the (C) component in the ultraviolet-curable adhesive composition is typically 20 to 90 weight %, preferably 20 to 70 weight %, more preferably 30 to 60 weight % with respect to the total amount of the adhesive composition.

In the present invention, the proportions (weight ratio) of the (A) component and the component of the formula (3) range preferably from 1:2 to 1:25, particularly preferably from 1:3 to 1:15.

The ultraviolet-curable adhesive composition of the present invention may use epoxy (meth)acrylates, provided that it is not detrimental to the characteristics of the present invention. Epoxy (meth)acrylates function to improve curability, or the hardness or cure rate of the cured product. Any epoxy (meth)acrylate may be used, as long as it is one obtained by the reaction of a glycidyl ether-type epoxy compound and a (meth)acrylic acid. Examples of glycidyl ether-type epoxy compounds that can be used to obtain an epoxy (meth)acrylate preferred for use include: a diglycidyl ether of bisphenol A or an alkylene oxide adduct thereof, a diglycidyl ether of bisphenol F or an alkylene oxide adduct thereof, a diglycidyl ether of hydrogenated bisphenol A or an alkylene oxide adduct thereof, a diglycidyl ether of hydrogenated bisphenol F or an alkylene oxide adduct thereof, ethylene glycol diglycidyl ether, propylene glycol diglycidyl ether, neopentyl glycol diglycidyl ether, butanediol diglycidyl ether, hexanediol diglycidyl ether, cyclohexane dimethanol diglycidyl ether, and polypropylene glycol diglycidyl ether.

The epoxy (meth)acrylates are obtained by reacting these glycidyl ether-type epoxy compounds with a (meth)acrylic acid under the following conditions.

A (meth)acrylic acid is reacted in a proportion of 0.9 to 1.5 moles, more preferably 0.95 to 1.1 moles per equivalent of the epoxy group of the glycidyl ether-type epoxy compound. The reaction temperature is preferably 80 to 120° C., and the reaction time is about 10 to 35 hours. It is preferable to use catalysts, for example, such as triphenylphosphine, TAP, triethanolamine, and tetraethylammonium chloride to promote reaction. It is also possible to use, for example, p-methoxyphenol or methylhydroquinone as a polymerization inhibitor to prevent polymerization during the reaction.

The epoxy (meth)acrylate preferred for use in the present invention is a bisphenol A type epoxy (meth)acrylate obtained from a bisphenol A type epoxy compound. The epoxy (meth)acrylates have a weight-average molecular weight of preferably 500 to 10,000.

The weight proportion of the epoxy (meth)acrylate in the ultraviolet-curable adhesive composition of the present invention is typically 1 to 80 weight %, preferably 5 to 30 weight %.

The photopolymerization initiator (D) contained in the composition of the present invention is not particularly limited. Examples of the photopolymerization initiator (D) include 2,4,6-trimethylbenzoyldiphenylphosphine oxide, 2,4,6-trimethylbenzoylphenylethoxyphosphine oxide, bis(2,4,6-trimethylbenzoyl)-phenylphosphine oxide, bis(2,6-dimethoxybenzoyl)-2,4,4-trimethyl-pentylphosphine oxide, 1-hydroxycyclohexyl phenyl ketone (Irgacure 184; manufactured by BASF), 2-hydroxy-2-methyl-[4-(l-methylvinyl)phenyl]propanol oligomer (ESACURE ONE; manufactured by Lamberti), 1-[4-(2-hydroxyethoxy)-phenyl]-2-hydroxy-2-methyl-1-propan-1-one (Irgacure 2959; manufactured by BASF), 2-hydroxy-1-{4-[4-(2-hydroxy-2-methyl-propionyl)-benzyl]-phenyl}-2-methyl-propan-1-one (Irgacure 127; manufactured by BASF), 2,2-dimethoxy-2-phenylacetophenone (Irgacure 651; manufactured by BASF), 2-hydroxy-2-methyl-1-phenyl-propan-1-one (Darocur 1173; manufactured by BASF), 2-methyl-1-[4-(methylthio)phenyl]-2-morpholinopropan-1-one (Irgacure 907; manufactured by BASF), a mixture of an oxy-phenyl-acetic acid 2-[2-oxo-2-phenyl-acetoxy-ethoxy]-ethyl ester and an oxy-phenyl-acetic acid 2-[2-hydroxy-ethoxy]-ethyl ester (Irgacure 754; manufactured by BASF), 2-benzyl-2-dimethylamino-1-(4-morpholinophenyl)-butan-1-one, 2-chlorothioxanthone, 2,4-dimethylthioxanthone, 2,4-diisopropylthioxanthone, and isopropylthioxanthone.

The photopolymerization initiator (D) used in the present invention is preferably a photopolymerization initiator having a molar absorptivity of 300 ml/(g·cm) or more at 302 nm or 313 nm, and a molar absorptivity of 100 ml/(g·cm) or less at 365 nm as measured in acetonitrile or methanol. Such a photopolymerization initiator can contribute to improving bonding strength. The curing in Step 3 below becomes sufficient with a molar absorptivity of 300 ml/(g·cm) or more at 302 nm or 313 nm. On the other hand, with a molar absorptivity of 100 ml/(g·cm) or less at 365 nm, any excess curing in Step 1 below can be appropriately inhibited, and the adhesion can improve.

Examples of such a photopolymerization initiator (D) include 1-hydroxycyclohexyl phenyl ketone (Irgacure 184; manufactured by BASF), 2-hydroxy-2-methyl-1-phenyl-propan-1-one (Darocur 1173; manufactured by BASF), l-[4-(2-hydroxyethoxy)-phenyl-]-2-hydroxy-2-methyl-1-propan-1-one (Irgacure 2959; manufactured by BASF), and a phenylglyoxylic acid methyl ester (Darocur MBF; manufactured by BASF).

In the ultraviolet-curable adhesive composition of the present invention, the photopolymerization initiator (D) may be used by mixing one or more photopolymerization initiators (D) in any proportions. The weight proportion of the photopolymerization initiator (D) in the photo-curable adhesive composition of the present invention is typically 0.2 to 5 weight %, preferably 0.3 to 3 weight %. When the weight proportion of the photopolymerization initiator (D) is above 5 weight %, the cured product layer having a cured portion and an uncured portion opposite the optical base material may fail to form the uncured portion when being formed, or the resin cured product layer may suffer from poor transparency.

The ultraviolet-curable adhesive composition of the present invention may contain other components, including, for example, the softening component (E), and the additives described below. The proportion of such other components in the total amount of the ultraviolet-curable adhesive composition of the present invention is the remainder calculated as the total amount minus the total amount of the (A) component, the (B) component, the (C) component, and the (D) component. Specifically, the total amount of other components is about 5 to 75 weight %, preferably about 15 to 75 weight %, more preferably about 35 to 65 weight % with respect to the total amount of the ultraviolet-curable adhesive composition of the present invention.

Amines that can serve as a photo-polymerization initiation auxiliary agent may be used with the photopolymerization initiator. Examples of such amines include a benzoic acid 2-dimethylaminoethyl ester, dimethylaminoacetophenone, a p-dimethylaminoethyl benzoate ester, and a p-dimethylaminobenzoic acid isoamyl ester. When using a photo-polymerization initiation auxiliary agent such as amines, the content thereof in the bonding adhesive composition of the present invention is typically 0.005 to 5 weight %, preferably 0.01 to 3 weight %.

The ultraviolet-curable adhesive composition of the present invention may use a softening component (E), as needed. Specific examples of the softening component include polymers, oligomers, phthalic acid esters, phosphoric acid esters, glycol esters, citric acid esters, aliphatic dibasic acid esters, fatty acid esters, epoxy-based plasticizers, castor oils, terpene-based resins, hydrogenated terpeno-based resins, and liquid terpene that are miscible in the composition. Examples of the oligomers and polymers include oligomers and polymers having a polyisoprene skeleton, a hydrogenated polyisoprene skeleton, a polybutadiene skeleton, a hydrogenated polybutadiene skeleton, or a xylene skeleton, and esterified products thereof, and polybutenes. Preferred from the viewpoint of transparency are hydrogenated terpene-based resins, hydrogenated polyisoprenes, hydrogenated polybutadienes, polybutenes, and liquid terpene. Particularly preferred from the viewpoints of bonding strength and compatibility with other materials are hydroxyl group-containing polymers such as hydrogenated terpene-based resins containing a hydroxyl group at the terminal or on side chains, hydrogenated polyisoprenes containing a hydroxyl group at the terminal or on side chains, and hydrogenated polybutadienes containing a hydroxyl group at the terminal or on side chains, and liquid terpene resins.

The weight proportion of the softening component in the ultraviolet-curable adhesive composition is typically 5 to 40 weight %, preferably 10 to 35 weight % when using a solid softening component. When using a liquid softening component, the weight proportion thereof is typically 10 to 70 weight %, preferably 20 to 60 weight %.

Additives such as antioxidants, organic solvents, silane coupling agents, polymerization inhibitors, leveling agents, antistatic agents, surface lubricants, fluorescent bleaches, light stabilizers (for example, such as hindered amine compounds), and fillers may be added to the ultraviolet-curable adhesive composition of the present invention, as required.

Specific examples of the antioxidants include BHT, 2,4-bis-(n-octylthio)-6-(4-hydroxy-3,5-di-t-butylanilino)-1,3,5-triazine, pentaerythrityl•tetrakis[3-(3,5-di-t-butyl-4-hydroxyphenyl)propionate], 2,2-thio-diethylenebis[3-(3,5-di-t-butyl-4-hydroxyphenyl)propionate], triethylene glycol-bis[3-(3-t-butyl-5-methyl-4-hydroxyphenyl)propionate], 1,6-hexanediol-bis[3-(3-t-butyl-5-methyl-4-hydroxyphenyl)propionate], octadecyl-3-(3,5-di-t-butyl-4-hydroxyphenyl)propionate, N,N-hexamethylene bis(3,5-di-t-butyl-4-hydroxy-hydrocinnamamide), 1,3,5-trimethyl-2,4,6-tris(3,5-t-butyl-4-hydroxybenzyl)benzene, tris-(3,5-di-t-butyl-4-hydroxybenzyl)-isocyanurate, octylated diphenylamine, 2,4-bis[(octylthio)methyl-O-cresol, isooctyl-3-(3,5-di-t-butyl-4-hydroxyphenyl)propionate], and dibutylhydroxytoluene.

Specific examples of the organic solvents include alcohols such as methanol, ethanol, and isopropyl alcohol; dimethylsulfone, dimethylsulfoxide, tetrahydrofuran, dioxane, toluene, and xylene.

Specific examples of the silane coupling agents include:

silane-based coupling agents such as 3-glycidoxypropyltrimethoxysilane, 3-glycidoxypropylmethyldimethoxysilane, 3-glycidoxypropylmethyldimethoxysilane, 2-(3,4-epoxycyclohexyl)ethyltrimethoxysilane, N-(2-aminoethyl) 3-amninopropylmethyldimethoxysilane, γ-mercaptopropyltrimethoxysilane, N-(2-aminoethyl) 3-aminopropylmethyltriethoxysilane, 3-aminopropyltriethoxysilane, 3-mercaptopropyltrimethoxysilane, vinyltrimethoxysilane, N-(2-(vinylbenzylamino)ethyl) 3-aminopropyltrimethoxysilanehydrochloride, 3-(meth)acryloxypropyltrimethoxysilane, 3-chloropropylmethyldimethoxysilane, and 3-chloropropyhtrimethoxysilane;

titanium-based coupling agents such as isopropyl(N-ethylaminoethylamino)titanate, isopropyl triisostearoyl titanate, titanium di(dioctylpyrophosphate)oxyacetate, tetraisopropyl di(dioctylphosphite)titanate, and neoalkoxy tri(p-N-(β-aminoethyl)aminophenyl)titanate; and

zirconium- or aluminum-based coupling agents such as Zr-acetyl acetonate, Zr-methacrylate, Zr-propionate, neoalkoxy zirconate, neoalkoxy trisneodecanoyl zirconate, neoalkoxy tris(dodecanoyl)benzenesulfonyl zirconate, neoalkoxy tris(ethylenediaminoethyl)zirconate, neoalkoxy tris(m-aminophenyl)zirconate, ammonium zirconium carbonate, Al-acetylacetonate, Al-methacrylate, and Al-propionate.

Specific examples of the polymerization inhibitors include p-methoxyphenol, and methylhydroquinone.

Specific examples of the light stabilizers include 1,2,2,6,6-pentamethyl-piperidyl alcohol, 2,2,6,6-tetramethyl-4-piperidyl alcohol, 1,2,2,6,6-pentamethyl-4-piperidyl (meth)acrylate (Adeka product, LA-82), tetrakis(1,2,2,6,6-pentamethyl-4-piperidyl)-1,2,3,4-butane tetracarboxylate, tetrakis(2,2,6,6-tetramethyl-4-piperidyl)-1,2,3,4-butane tetracarboxylate, an esterification product of 1,2,3,4-butanetetracarboxylic acid with 1,2,2,6,6-pentamethyl-4 piperidinol and 3,9-bis(2-hydroxy-1,1-dimethylethyl)-2,4,8,10-tetraoxaspiro[5.5]undecane, decanedioic acid bis(2,2,6,6-tetramethyl-4-piperidyl)sebacate, bis(1-undecaneoxy-2,2,6,6-tetramethylpiperidin-4-yl)carbonate, 2,2,6,6-tetramethyl-4-piperidyl methacrylate, bis(2,2,6,6-tetramethyl-4-piperidyl)sebacate, bis(1,2,2,6,6-pentamethyl-4-piperidyl)sebacate, 4-benzoyloxy-2,2,6,6-tetramethylpiperidine, 1-[2-[3-(3,5-di-tert-butyl-4-hydroxyphenyl)propionyloxy]ethyl]-4-[3-(3,5-di-tert-butyl-4-hydroxyphenyl)propionyloxy]-2,2,6,6-tetramethylpiperidine, 1,2,2,6,6-pentamethyl-4-piperidinyl-(meth)acrylate, bis(1,2,2,6,6-pentamethyl-4-piperidinyl)[[3,5-bis(1,1-dimethylethyl)-4-hydroxyphenyl]methyl]butyl malonate, decanedioic acid bis(2,2,6,6-tetramethyl-1(octyloxy)-4-piperidinyl)ester, a reaction product of 1,1-dimethylethyl hydroperoxide and octane, N,N′,N″,N′″-tetrakis-4,6-bis-(butyl-(N-methyl-2,2,6,6-tetramethylpiperidin-4-yl)amino)-triazin-2-yl)-4,7-diazadecane-1,10-diamine, a polycondensate of dibutylamine-1,3,5-triazine-N,N′-bis(2,2,6,6-tetramethyl-4-piperidyl-1,6-hexamethylenediamine and N-(2,2,6,6-tetramethyl-4-piperidyl)butylamine, poly[[6-(1,1,3,3-tetramethylbutyl)amino-1,3,5-triazine-2,4-diyl][(2,2,6,6-tetramethyl-4-piperidyl)imino]hexamethylene[(2,2,6,6-tetramethyl-4-piperidyl)imino]], a polymerization product of dimethyl succinate and 4-hydroxy-2,2,6,6-tetramethyl-1-piperidine ethanol, 2,2,4,4-tetramethyl-20-(β-lauryloxycarbonyl)ethyl-7-oxa-3,20-diazadispiro[5.1.11.2]heneicosan-21-one, β-alanine,N,-(2,2,6,6-tetramethyl-4-piperidinyl)-dodecyl ester/tetradecyl ester, N-acetyl-3-dodecyl-1-(2,2,6,6-tetramethyl-4-piperidinyl)pyrrolidine-2,5-dione, 2,2,4,4-tetramethyl-7-oxa-3,20-diazadispiro[5,1,11,2]heneicosan-21-one, 2,2,4,4-tetramethyl-21-oxa-3,20-diazabicyclo-[5,1,11,2]-heneicosane-20-propanoic acid dodecyl ester/tetradecyl ester, propanedioic acid, [(4-methoxyphenyl)-methylene]-bis(1,2,2,6,6-pentamethyl-4-piperidinyl)ester, a higher fatty acid ester of 2,2,6,6-tetramethyl-4-piperidinol, 1,3-benzene dicarboxamide, hindered amine-based compounds (such as N,N′-bis(2,2,6,6-tetramethyl-4-piperidinyl)), benzophenone-based compounds (such as octabenzone), 2-(2H-benzotriazol-2-yl)-4-(1,1,3,3-tetramethylbutyl)phenol, 2-(2-hydroxy-5-methylphenyl)benzotriazole, 2-[2-hydroxy-3-(3,4,5,6-tetrahydrophthalimide-methyl)-5-methylphenyl]benzotriazole, 2-(3-tert-butyl-2-hydroxy-5-methylphenyl)-5-chlorobenzotriazole, 2-(2-hydroxy-3,5-di-tert-pentylphenyl)benzotriazole,

a reaction product of methyl 3-(3-(2H-benzotriazol-2-yl)-5-tert-butyl-4-hydroxyphenyl)propionate and polyethylene glycol, benzotriazole-based compounds (such as 2-(2H-benzotriazol-2-yl)-6-dodecyl-4-methylphenol), benzoate-based compounds (such as 2,4-di-tert-butylphenyl-3,5-di-ten-butyl-4-hydroxybenzoate), and triazine-based compounds (such as 2-(4,6-diphenyl-1,3,5-triazin-2-yl)-5-[(hexyl)oxy]phenol). Particularly preferred are hindered amine-based compounds.

Specific examples of the fillers include powders such as crystal silica, molten silica, alumina, zircon, calcium silicate, calcium carbonate, silicon carbide, silicon nitride, boron nitride, zirconia, forsterite, steatite, spinel, titania, and talc, and spheronized beads thereof

When various additives are present in the composition, the weight proportion of each additive in the photo-curable transparent adhesive composition is 0.01 to 3 weight %, preferably 0.01 to 1 weight %, more preferably 0.02 to 0.5 weight %.

The ultraviolet-curable adhesive composition of the present invention may be obtained by mixing and dissolving the foregoing components at ordinary temperature to 80° C., and foreign substances may be removed by procedures such as filtration, as required. Considering applicability, it is preferable to appropriately adjust the mixture ratio of the components of the bonding adhesive composition of the present invention so that the viscosity at 25° C. is 300 to 40,000 mPa·s.

Preferred embodiments of steps for producing an optical member using the ultraviolet-curable adhesive composition of the present invention are described below.

In the optical member producing method of the present invention, it is preferable to laminate at least two optical base materials in the following (Step 1) to (Step 3). Step 3 may be omitted if it is determined that sufficient bonding strength can be ensured after Step 2.

### (Step 1)

Step 1 is the step of obtaining an optical base material having a cured product layer that has a cured portion and an uncured portion. The cured portion (hereinafter, “cured portion of a cured product layer”, or, simply “cured portion”) is a portion of a coating layer that is present on the optical base material side (the lower side of the coating layer) after coating at least one optical base material with the ultraviolet-curable adhesive composition, and applying ultraviolet rays to the coating layer formed. The uncured portion (hereinafter, “uncured portion of a cured product layer”, or, simply “uncured portion”) is a portion that is present on the side opposite the optical base material (the upper side of the coating layer, typically the atmosphere side). In Step 1, the extent of curing in the coating layer after ultraviolet irradiation is not particularly limited, as long as the uncured portion is present on the surface opposite the optical base material (the upper side of the coating layer, typically the atmosphere side). The uncured portion can be determined as being present when the liquid component sticks to a finger upon touching the side opposite the optical base material (the upper side of the coating layer, typically the atmosphere side) with a finger.

### (Step 2)

Step 2 is the step of laminating another optical base material, or the uncured portion of the cured product layer of another optical base material obtained in Step 1, on the uncured portion of the cured product layer of the optical base material obtained in Step 1.

### (Step 3)

Step 3 is the step of curing the cured product layer by applying ultraviolet rays to the cured product layer having the uncured portion after laminating the optical base materials, the ultraviolet rays being applied through an optical base material having a light-shielding portion.

The following describes specific embodiments of the optical member producing method of the present invention through Step 1 to Step 3, with reference to drawings representing an example in which a liquid crystal display unit and a transparent substrate having a light-shielding portion are laminated to each other.

The ultraviolet-curable adhesive composition of the present invention can provide a particularly desirable bonding effect, and prevent air trapping when cured by ultraviolet rays after being applied in the form of a liquid resin to at least one of two or more substrates being laminated, and in the form of a liquid resin or in a state having the uncured portion to the other substrates. The ultraviolet-curable adhesive composition of the present invention is therefore particularly preferred for use in such an application.

### First Embodiment

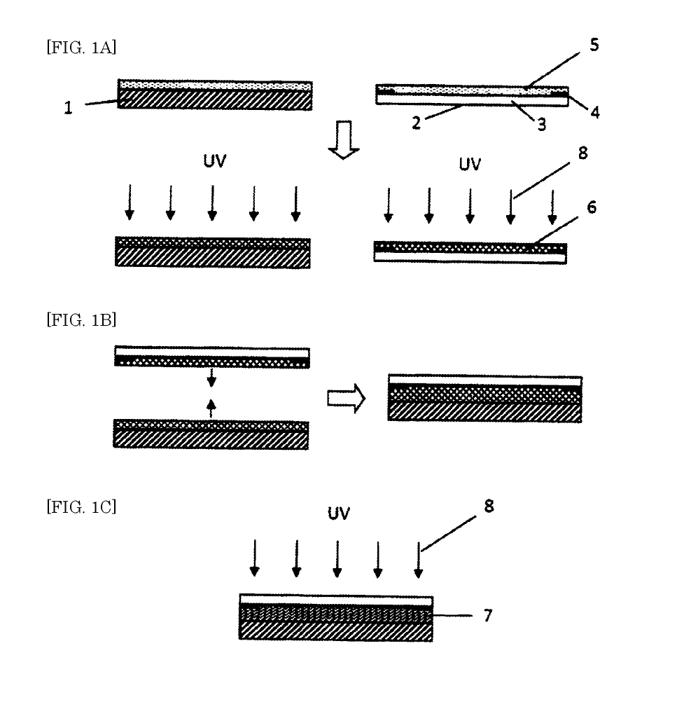

FIG. 1 is a step diagram representing First Embodiment of optical member producing steps using the ultraviolet-curable adhesive composition of the present invention.

The method laminates a liquid crystal display unit 1 and a transparent substrate 2 to obtain an optical member.

The liquid crystal display unit 1 is of a construction in which a liquid crystal material is sealed between a pair of electrode-equipped substrates, and that includes polarizing plates, a drive circuit, signal input cables, and a backlight unit.

The transparent substrate 2 is a transparent substrate such as a glass plate, a polymethyl methacrylate (PMMA) plate, a polycarbonate (PC) plate, and an alicyclic polyolefin polymer (COP) plate.

The transparent substrate 2 is preferably one that has a black-frame light-shielding portion 4 on a transparent substrate surface. The light-shielding portion 4 is formed by methods such as attaching a tape, and applying or printing a coating material. The present invention is also applicable to materials without the light-shielding portion 4. However, the descriptions of First to Third Embodiments below are based on a specific example with the light-shielding portion 4. For applications without the light-shielding portion 4, the descriptions below can be regarded as having no light-shielding portion when “transparent substrate having a light-shielding portion” is read as “transparent substrate”.

### (Step 1)

First, as illustrated in FIG. 1(a), the ultraviolet-curable adhesive composition is applied to the display surface of the liquid crystal display unit 1, and to the surface on the side of the light-shielding portion of the transparent substrate 2 having the light-shielding portion. The composition may be applied by using methods such as slit coating, roll coating, spin coating, and screen printing. Here, the same or different ultraviolet-curable adhesive compositions may be applied to the surfaces of the liquid crystal display unit 1 and the transparent substrate 2 having the light-shielding portion. Typically, it is preferable to apply the same ultraviolet-curable adhesive composition.

The thickness of the cured product of each ultraviolet curable resin is adjusted so that the resin cured product layer 7 has a thickness of 50 to 500 μm, preferably 50 to 350 μm, further preferably 100 to 350 μm after the lamination. Typically, the thickness of the cured product layer of the ultraviolet curable resin on the surface of the transparent substrate 2 having the light-shielding portion is preferably about the same or thicker than the thickness of the cured product layer of the ultraviolet curable resin on the surface of the liquid crystal display unit 1, though this depends on the thickness. This is to minimize the portions that remain uncured after ultraviolet irradiation in Step 3 below, and eliminate the risk of a cure failure.

After application, the ultraviolet-curable adhesive composition layer 5 is irradiated with ultraviolet rays 8 to obtain a cured product layer 6 having a cured portion and an uncured portion. The cured portion (not shown in the figure) is a portion that is present on the lower side of the coating layer (the liquid crystal display unit or transparent substrate side relative to the ultraviolet-curable adhesive composition). The uncured portion (not shown in the figure) is a portion that is present on the upper side of the coating layer (the side opposite the liquid crystal display unit or the transparent substrate; the atmosphere side when the optical member is produced in the atmosphere). The irradiation amount is preferably 5 to 2,000 mJ/cm², particularly preferably 10 to 1,000 mJ/cm². When the irradiation amount is too small, the extent of curing may become insufficient in the resin of the laminated optical member product. When the irradiation amount is excessive, the uncured component may decrease, and a lamination failure may occur between the liquid crystal display unit 1 and the transparent substrate 2 having the light-shielding portion.

As used herein, “uncure” refers to a state involving fluidity in a 25° C. environment. The uncured portion is determined as being present when the liquid component sticks to a finger upon touching the adhesive composition layer with a finger after the ultraviolet irradiation.

The light source used for the curing by ultraviolet to near-ultraviolet rays is not limited, as long as it is a lamp that emits ultraviolet to near-ultraviolet rays. Examples of such lamps include a low-pressure, high-pressure, or ultrahigh-pressure mercury lamp, a metal halide lamp, a (pulse) xenon lamp, and an electrodeless lamp.

In Step 1 of the present invention, the wavelength of the ultraviolet rays applied to the ultraviolet-curable adhesive composition is not particularly limited, and is preferably the wavelength that has the maximum illuminance ratio (illuminance ratio) of preferably 30 or less, particularly preferably 10 or less in a 200 to 320 nm range relative to the maximum illuminance of 100 taken in a 320 nm to 450 nm range.

The bonding strength of the product optical member suffers when the maximum illuminance ratio (illuminance ratio) in a 200 to 320 nm range is above 30 relative to the maximum illuminance of 100 taken in a 320 nm to 450 nm range. This is probably because, when the illuminance at the lower wavelengths is high, the ultraviolet-curable adhesive composition undergoes excessive curing when being cured Step 1, and becomes less contributory to adhesion upon being cured by ultraviolet irradiation in Step 3.

The method used to apply ultraviolet rays to produce the foregoing illuminance ratios may be, for example, a method that uses, an ultraviolet to near-ultraviolet lamp that satisfies the foregoing illuminance ratio conditions, or a method in which a lamp, which does not satisfy the foregoing illuminance conditions by itself, is used with a base material (for example, such as a short-wavelength ultraviolet cut filter, a glass plate, and a film) that cuts ultraviolet light of shorter wavelengths applied in Step 1. The base material used to adjust the illuminance ratio of ultraviolet rays may be, for example, a glass plate, a soda-lime glass, or a PET film that has been processed to cut ultraviolet light of shorter wavelengths, though it is not particularly limited. It should be noted here that a base material, such as an attenuation plate, that is prepared from materials such as fused quartz that has been processed to have irregularities on its surface is not particularly effective. Such base materials achieve low illuminance by scattering light, and are accordingly not suited to selectively reduce illuminance of shorter wavelengths of 320 n or less.

In Step 1, it is preferable to apply ultraviolet rays typically in the atmosphere, from the upper side of the coated surface (the side opposite the liquid crystal display unit or the transparent substrate relative to the ultraviolet-curable adhesive composition; typically, the atmosphere surface). It is also possible to perform ultraviolet irradiation while spraying a cure inhibitory gas to the upper surface of the coating layer after creating a vacuum. The side opposite the liquid crystal display unit or the transparent substrate becomes the atmosphere side when the adhesive composition is cured in the atmosphere. When it is desired to improve the surface stickiness of the coating layer formed in Step 1, ultraviolet rays may be applied in a vacuum environment, or in a gas environment, such as in nitrogen, where curing is not inhibited.

On the other hand, when Step 3 is omitted, curing can be desirably performed in a vacuum, or while spraying a gas that promotes curing (for example, nitrogen). In this way, sufficient bonding can be achieved even without Step 3.

The state or the thickness of the uncured portion may be adjusted by blowing oxygen or ozone to the surface of the ultraviolet curable resin layer (coating layer) during the ultraviolet irradiation.

Specifically, the oxygen or ozone blown onto the coating layer surface inhibits the curing of the ultraviolet-curable adhesive composition on the surface, and ensures providing the uncured portion on the surface, or increases the thickness of the uncured portion.

### (Step 2)

In the next step, the liquid crystal display unit 1, and the transparent substrate 2 having the light-shielding portion are laminated to each other with the uncured portions facing each other, as illustrated in FIG. 1(b). The lamination may be made in the atmosphere or in a vacuum.

Here, it is preferable to laminate the two in a vacuum to prevent bubbles from occurring during the lamination.

Improved adhesion can be expected when the liquid crystal display unit and the transparent substrate are laminated after obtaining the cured product of the ultraviolet curable resin having a cured portion and an uncured portion.

The lamination may be performed by, for example, applying pressure, or pressing.

### (Step 3)

In the next step, the optical member obtained by laminating the transparent substrate 2 and the liquid crystal display unit 1 is irradiated with ultraviolet rays 8 from 1.0 the side of the transparent substrate 2 having the light-shielding portion to cure the ultraviolet-curable adhesive composition (coating layer), as illustrated in FIG. 1(c).

Ultraviolet rays are applied in a cumulative light quantity of preferably about 100 to 4,000 mJ/cm², particularly preferably about 200 to 3,000 mJ/cm². The light source used for the curing by ultraviolet to near-ultraviolet rays is not limited, as long as it is a lamp that emits ultraviolet to near-ultraviolet rays. Examples of such lamps include a low-pressure, high-pressure, or ultrahigh-pressure mercury lamp, a metal halide lamp, a (pulse) xenon lamp, and an electrodeless lamp.

The optical member shown in FIG. 4 can be obtained in the manner described above.

### Second Embodiment

The optical member of the present invention may also be produced according to Second Embodiment, which is a modification of First Embodiment, as follows. Note that details of each step are as described in First Embodiment, and will not be described where there is redundancy.

### (Step 1)

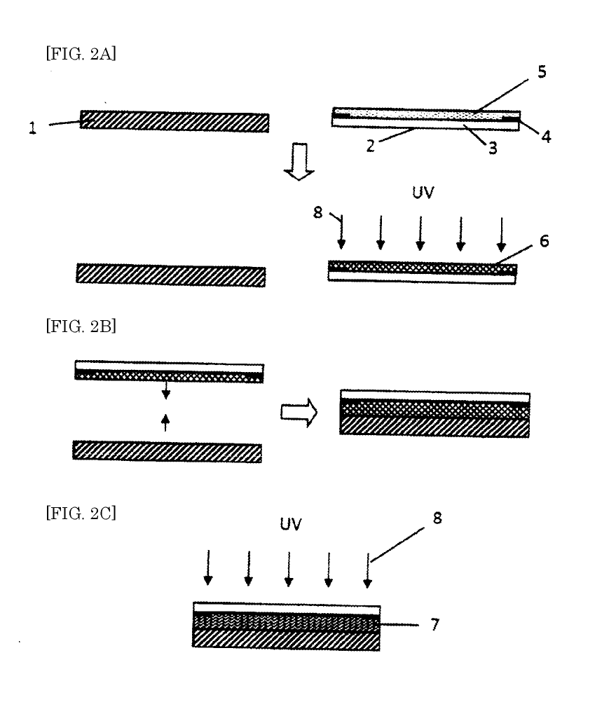

First, as illustrated in FIG. 2(a), the ultraviolet curable composition is applied to the transparent substrate 2 having the light-shielding portion. Here, the ultraviolet curable composition is applied to the surface on which the light-shielding portion 4 is formed. The resulting coating layer (ultraviolet-curable adhesive composition layer 5) is then irradiated with ultraviolet rays 8 to obtain a cured product layer 6 having a cured portion and an uncured portion. The cured portion is a portion that is present on the lower side of the coating layer (the transparent substrate side relative to the ultraviolet-curable adhesive composition). The uncured portion is a portion that is present on the upper side of the coating layer (the opposite side from the transparent substrate).

Here, the wavelength of the ultraviolet rays applied to the ultraviolet-curable adhesive composition is not particularly limited, and is preferably the wavelength that has the maximum illuminance ratio of preferably 30 or less, particularly preferably 10 or less in a 200 to 320 nm range relative to the maximum illuminance of 100 taken in a 320 nm to 450 nm range. The bonding strength of the product optical member suffers when the maximum illuminance ratio in a 200 to 320 nm range is above 30 relative to the maximum illuminance of 100 taken in a 320 nm to 450 nm range.

### (Step 2)

In the next step, as illustrated in FIG. 2(b), the liquid crystal display unit 1, and the transparent substrate 2 having the light-shielding portion are laminated to each other with the uncured portion of the cured product layer 6 obtained facing the display surface of the liquid crystal display unit 1. The lamination may be made in the atmosphere or in a vacuum.

### (Step 3)

In the next step, as illustrated in FIG. 2(c), the optical member obtained by laminating the transparent substrate 2 and the liquid crystal display unit 1 is irradiated with ultraviolet rays 8 from the side of the transparent substrate 2 having the light-shielding portion to cure the cured product layer 6 having the uncured portion of the ultraviolet-curable adhesive composition.

The optical member shown in FIG. 4 can be obtained in the manner described above.

### Third Embodiment

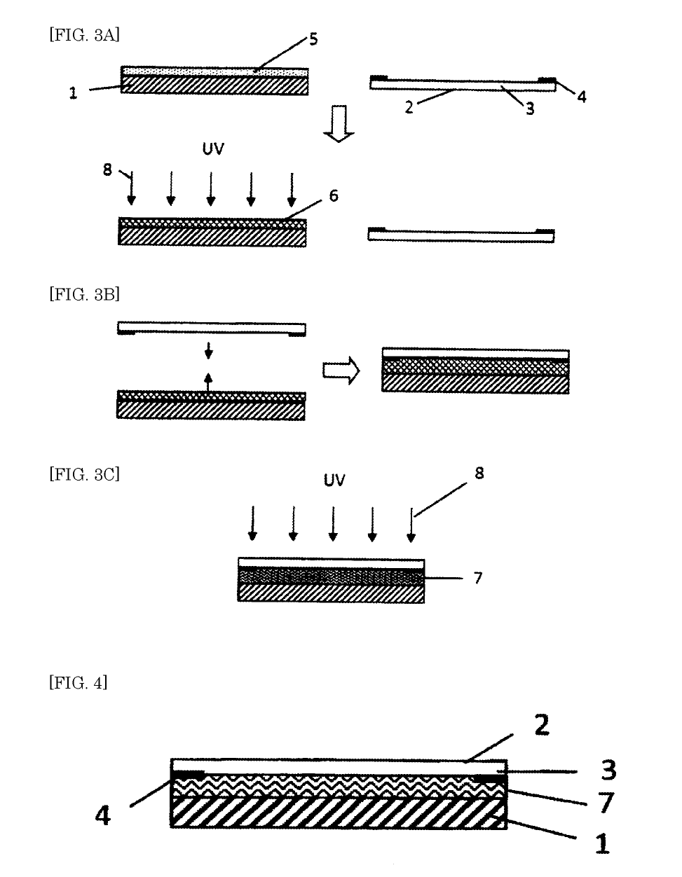

FIG. 3 is a step diagram representing Third Embodiment of the optical member producing method using the ultraviolet-curable adhesive composition of the present invention. Note that details of each step are as described in First Embodiment, and will not be described where there is redundancy.

The same constituent members described in First Embodiment are given the same reference numerals in the figure, and will not be described again.

### (Step 1)

First, as illustrated in FIG. 3(a), the ultraviolet curable composition is applied to a surface of the liquid crystal display unit 1. The ultraviolet-curable adhesive composition layer 5 is then irradiated with ultraviolet rays 8 to obtain a cured product layer 6 having a cured portion and an uncured portion. The cured portion is a portion that is present on the lower side of the coating layer (the transparent substrate side relative to the ultraviolet-curable adhesive composition). The uncured portion is a portion that is present on the upper side of the coating layer (the opposite side from the transparent substrate).

Here, the wavelength of the ultraviolet rays applied to the ultraviolet-curable adhesive composition is not particularly limited, and is preferably the wavelength that has the maximum illuminance ratio of preferably 30 or less, particularly preferably 10 or less in a 200 to 320 nm range relative to the maximum illuminance of 100 taken in a 320 nm to 450 nm range. The bonding strength of the product optical member suffers when the maximum illuminance ratio in a 200 to 320 nm range is above 30 relative to the maximum illuminance of 100 taken in a 320 nm to 450 nm range.

### (Step 2)

In the next step, as illustrated in FIG. 3(b), the liquid crystal display unit 1, and the transparent substrate 2 having the light-shielding portion are laminated to each other with the uncured portion of the cured product layer 6 facing the surface on the side of the light-shielding portion of the transparent substrate 2 having the light-shielding portion. The lamination may be made in the atmosphere or in a vacuum.

### (Step 3)

In the next step, as illustrated in FIG. 3(c), the optical member obtained by laminating the transparent substrate 2 and the liquid crystal display unit 1 is irradiated with ultraviolet rays 8 from the side of the transparent substrate 2 having the light-shielding portion to cure the cured product layer 6 having the uncured portion of the ultraviolet-curable adhesive composition.

The optical member shown in FIG. 4 can be obtained in the manner described above.

The foregoing embodiments describe some embodiments of the optical member producing method of the present invention based on a specific optical base material. Whereas each embodiment is described with a liquid crystal display unit and a transparent substrate having a light-shielding portion, the producing method of the present invention may use various other members (described later) as optical base materials, in addition to the liquid crystal display unit. The transparent substrate also may be an optical base material selected from various members, as will be described later.

In addition to such members, optical base materials such as the liquid crystal display unit and the transparent substrate also may use other optical base material layers (for example, a film laminated with the cured product layer of the ultraviolet-curable adhesive composition, or a laminate with other optical base material layers).

The foregoing descriptions of First Embodiment, including the coating method of the ultraviolet-curable adhesive composition, the thickness of the resin cured product, the irradiation amount and the light source of ultraviolet irradiation, and the method for adjusting the thickness of the uncured portion by blowing oxygen or nitrogen, or ozone to the surface of the ultraviolet curable resin layer are not limited to the foregoing embodiments, and are applicable to all forms of the producing method of the present invention.

Specific forms of optical members, including the liquid crystal display unit, that can be produced according to First to Third Embodiments are as follows.

(i) The optical base material having a light-shielding portion is at least one optical base material selected from the group consisting of a transparent glass substrate having a light-shielding portion, a transparent resin substrate having a light-shielding portion, and a glass substrate that includes a light-shielding portion and a transparent electrode formed thereon. The optical base material laminated to the optical base material having a light-shielding portion is at least one display unit selected from the group consisting of a liquid crystal display unit, a plasma display unit, and an organic EL unit. The resulting optical member is a display unit that has the optical base material having a light-shielding portion.

(ii) One of the optical base materials is a protecting base material having a light-shielding portion. The other optical base material laminated to the protecting base material is a touch panel, or a display unit having a touch panel. The optical member formed after laminating at least the two optical base materials is a touch panel that has the protecting base material having a light-shielding portion, or a display unit having the same.

In this case, it is preferable in Step 1 to apply the ultraviolet-curable adhesive composition to the side of the protecting base material having a light-shielding portion where the light-shielding portion is provided, and/or the touch screen surface of the touch panel.

(iii) One of the optical base materials is an optical base material having a light-shielding portion. The other optical base material laminated to the optical base material having a light-shielding portion is a display unit. The optical member obtained after laminating at least the two optical base materials is a display unit that has the optical base material having a light-shielding portion.

In this case, it is preferable in Step 1 to apply the ultraviolet-curable adhesive composition to the side of the optical base material having a light-shielding portion where the light-shielding portion is provided, and/or the display surface of the display unit.

Specific examples of the optical base material having a light-shielding portion include a display screen protective plate having a light-shielding portion, and a touch panel provided with a protecting base material having a light-shielding portion.

The side of the optical base material having a light-shielding portion where the light-shielding portion is provided is, for example, the side of a protective plate where a light-shielding portion is provided, when the optical base material having a light-shielding portion is a display screen protective plate having a light-shielding portion. When the optical base material having a light-shielding portion is a touch panel that has a protecting base material having a light-shielding portion, the surface having the light-shielding portion of the protecting base material having a light-shielding portion is laminated to the touch screen surface of the touch panel. Accordingly, the side of the optical base material having a light-shielding portion where the light-shielding portion is provided means the base material surface of the touch panel opposite the touch screen surface of the touch panel.

The light-shielding portion of the optical base material having a light-shielding portion may be formed anywhere on the optical base material. Typically, the light-shielding portion is fabricated in the form of a frame around a transparent plate-like or a sheet-like optical base material, and has a width of about 0.5 mm to 10 mm, preferably about 1 to 8 mm, more preferably about 2 to 8 mm.

The ultraviolet-curable adhesive composition of the present invention may be used in the optical member producing method that laminates at least two optical base materials in the foregoing (Step 1) to (Step 2), optionally with (Step 3).

The cured product of the ultraviolet-curable adhesive composition of the present invention has a cure shrinkage rate of preferably 4.0% or less, particularly preferably 3.0% or less. In this way, the internal stress that accumulates in the resin cured product while curing the ultraviolet-curable adhesive composition can be reduced, and the strains that occur between the base material and the cured product layer of the ultraviolet-curable adhesive composition can be effectively prevented.

In the case where the base material is thin as in the case of glass, large warping occurs upon curing when the cure shrinkage rate is high. This causes serious adverse effects on display performance, and it is preferable to make the cure shrinkage rate small also from this standpoint.

The cured product of the ultraviolet-curable adhesive composition of the present invention has a transmittance of preferably 90% or more at 400 nm to 800 nm. This is because, when the transmittance is less than 90%, the cured product cannot easily transmit light, and lowers visibility when used in a display device.

Preferably, the transmittance at 400 to 450 nm is 90% or more because the cured product is expected to provide even better visibility when it has a high transmittance at 400 to 450 nm.

The ultraviolet-curable adhesive composition of the present invention may preferably be used as an adhesive for producing an optical member through lamination of a plurality of optical base materials according to the foregoing (Step 1) to (Step 3).

Examples of the optical base materials used in the optical member producing method of the present invention include a transparent plate, a sheet, a touch panel, and a display unit.

As used herein, “optical base material” means both an optical base material that does not have a light-shielding portion on its surface, and an optical base material that has a light-shielding portion on its surface. In the optical member producing method of the present invention, at least one of the optical base materials used is preferably an optical base material having a light-shielding portion.

The location of the light-shielding portion on the optical base material having a light-shielding portion is not particularly limited. In a preferred form, a stripe-like light-shielding portion is formed at the peripheral portion of the optical base material in a width of 0.05 to 20 mm, preferably about 0.05 to 10 mm, more preferably about 0.1 to 6 mm. The light-shielding portion on the optical base material may be formed by using methods such as attaching a tape, and applying or printing a coating material.

Various materials may be used as the material of the optical base material used in the present invention. Specific examples include resins such as PET, PC, PMMA, a composite of PC and PMMA, glass, COC, COP, and plastics (such as acrylic resin). When the optical base material used in the present invention is, for example, a transparent plate or a sheet, examples of the optical base material include a sheet or a transparent plate obtained by laminating a plurality of films or sheets such as polarizing plates, a non-laminated sheet or transparent plate, and transparent plates fabricated from inorganic glass (inorganic glass plates, and processed products thereof, for example, a lens, a prism, and ITO glass). Aside from the polarizing plates and the like described above, the optical base material used in the present invention include a laminate of a plurality of functional plates or sheets, such as the touch panel (touch panel input sensor), and the display unit below (hereinafter, such laminates will also be referred to as “functional laminates”).

Examples of the sheet that can be used as the optical base material used in the present invention include an icon sheet, a decorative sheet, and a protective sheet. Examples of the plate (transparent plate) that can be used in the optical member producing method of the present invention include a decorative plate, and a protective plate. The materials of these sheets and plates may be the same materials exemplified for the transparent plate.

Examples of the surface material of the touch panel that can be used as the optical base material used in the present invention include glass, PET, PC, PMMA, a composite of PC and PMMA, COC, and COP.

The thickness of plate-like or sheet-like optical base materials such as a transparent plate and a sheet is not particularly limited, and is typically about 5 μm to about 5 cm, preferably about 10 μm to about 10 mm, more preferably about 50 μm to 3 mm.

Examples of the preferred optical members obtained by using the producing method of the present invention include an optical member produced by laminating a plate-like or sheet-like transparent optical base material having a light-shielding portion to the functional laminate with the cured product of the ultraviolet-curable adhesive composition of the present invention.

A display unit equipped with an optical functional material (hereinafter, also referred to as “display panel”) may be produced by using a display unit such as a liquid crystal display device as an optical base material, and an optical functional material as another optical base material in the producing method of the present invention. Examples of the display unit include various display devices, including, for example, LCDs in which polarizing plates are attached to glass, EL displays, EL illuminations, electronic papers, and plasma displays. Examples of the optical functional material include transparent plastic plates (such as an acrylic plate, a PC plate, a PET plate, and a PEN plate), tempered glass, and a touch panel input sensor.

When used as an adhesive to bond the optical base materials, it is preferable that the cured product have a refractive index of 1.45 to 1.55 to improve visibility. This further improves the visibility of displayed image.

In this refractive index range, the refractive index difference from the base material used as the optical base material becomes smaller, and diffuse reflection of light can be inhibited to reduce light loss.

The preferred forms of the optical member obtained by using the producing method of the present invention include the following (i) to (vii).

(i) An optical member in which an optical base material having a light-shielding portion is laminated to the functional laminate with the cured product of the ultraviolet-curable adhesive composition of the present invention.

(ii) An optical member as described in (i) above in which the optical base material having a light-shielding portion is an optical base material selected from the group consisting of a transparent glass substrate having a light-shielding portion, a transparent resin substrate having a light-shielding portion, and a glass substrate having a light-shielding object and a transparent electrode formed thereon, and in which the functional laminate is a display unit or a touch panel.

(iii) An optical member as described in (ii) above in which the display unit is any one of a liquid crystal display unit, a plasma display unit, and an organic EL display unit.

(iv) A touch panel (or a touch panel input sensor) in which a plate-like or sheet-like optical base material having a light-shielding portion is laminated to the touch screen surface side of a touch panel with the cured product of the ultraviolet-curable adhesive composition of the present invention.

(v) A display panel in which a plate-like or sheet-like optical base material having a light-shielding portion is laminated onto the display screen of a display unit with the cured product of the ultraviolet-curable adhesive composition of the present invention.

(vi) A display panel as described in (v) above in which the plate-like or sheet-like optical base material having a light-shielding portion is a protecting base material for protecting the display screen of a display unit, or a touch panel.

(vii) An optical member, a touch panel, or a display panel as described in any one of (i) to (vi) above in which the ultraviolet-curable adhesive composition is the ultraviolet-curable adhesive composition of any one of the items (1) to (18) above.

The optical member of the present invention is obtained by laminating a plurality of optical base materials selected from the foregoing optical base materials with the ultraviolet-curable adhesive composition of the present invention using the method as described in (Step 1) to (Step 3) above. In Step 1, the ultraviolet-curable adhesive composition may be applied to one or both of the opposing surfaces of the two laminated optical base materials facing each other via the cured product layer.

For example, in the case of the optical member of (ii) in which the functional laminate is a touch panel or a display unit, the adhesive composition in Step 1 may be applied to one of the surfaces of the protecting base material having a light-shielding portion, preferably the surface provided with the light-shielding portion, and/or to the touch screen surface of the touch panel, or the display surface of the display unit.

In the case of the optical member of (vi) in which a protecting base material for protecting the display screen of a display unit, or a touch panel is laminated to the display unit, the adhesive composition in Step 1 may be applied to the protecting base material on the surface provided with the light-shielding portion, or the base material surface opposite the touch screen surface of the touch panel, and/or to the display surface of the display unit.

The optical member produced to include the display unit and the optical base material having a light-shielding portion according to the producing method of the present invention may be incorporated in, for example, electronic devices such as televisions, small-size gaming machines, cell phones, and personal computers.

### EXAMPLES

The present invention is described below in greater detail referring to Examples. The present invention, however, is in no way limited by the following Examples.

### Preparation of Ultraviolet-Curable Adhesive Composition

Compositions A to M were prepared by heating and mixing the components in the mixture ratios shown in Table 1.

TABLE 1

| | Compo- | Compo- | Compo- | Compo- | Compo- | Compo- | Compo- | Compo- | Compo- | Compo- | Compo- | Compo- | Compo- |
|---|---|---|---|---|---|---|---|---|---|---|---|---|---|
| | sition A | sition B | sition C | sition D | sition E | sition F | sition G | sition H | sition I | sition J | sition K | sition L | sition M |
| Note | Ex. | Ex. | Ex. | Ex. | Ex. | Ex. | Ex. | Ex. | Com. Ex. | Com. Ex. | Com. Ex. | Com. Ex. | Com. Ex. |
| B-1 | 16 | 16 | 16 | 16 | 16 | 16 | 16 | | 16 | 16 | 16 | 16 | |
| B-2 | | | | | | | | 16 | | | | | |
| E-1 | | | | | | | | | | | | | 16 |
| E-2 | 18 | 18 | 18 | 18 | 18 | 18 | 18 | 18 | 18 | 18 | 18 | 18 | 18 |
| E-3 | 18 | 16 | 14 | | 14 | 14 | 14 | 14 | 14 | 14 | 14 | 14 | 14 |
| E-4 | 10 | 10 | 10 | 24 | 10 | 10 | 10 | 10 | 10 | 10 | 10 | 10 | 10 |
| C-1 | | | | | | 45 | | | | | | | |
| C-2 | 45 | 45 | 45 | 45 | 45 | | | 45 | 45 | 45 | 45 | 45 | 45 |
| C-3 | | | | | | | 45 | | | | | | |
| A-1 | 2 | 4 | 6 | 6 | | 6 | 6 | 6 | | | | | 6 |
| A-2 | | | | | 6 | | | | | | | | |
| X-1 | | | | | | | | | | 6 | | | |
| X-2 | | | | | | | | | | | 6 | | |
| X-3 | | | | | | | | | | | | 6 | |
| D-1 | 0.5 | 0.5 | 0.5 | 0.5 | 0.5 | 0.5 | 0.5 | 0.5 | 0.5 | 0.5 | 0.5 | 0.5 | 0.5 |
| D-2 | 0.25 | 0.25 | 0.25 | 0.25 | 0.25 | 0.25 | 0.25 | 0.25 | 0.25 | 0.25 | 0.25 | 0.25 | 0.25 |
| Total | 109.8 | 109.8 | 109.8 | 109.8 | 109.8 | 109.8 | 109.8 | 109.8 | 103.8 | 109.8 | 109.8 | 109.8 | 109.8 |

A-1: 4HBA (4-hydroxybutyl acrylate; manufactured by Osaka Organic Chemical Industry Ltd.)
A-2: HOP-A (N) (2-hydroxypropyl acrylate; manufactured by Kyoeisha Chemical Co., Ltd.)
B-1: urethane acrylate (a reaction product of three components of hydrogenated polybutadienediol (molecular weight 2,000), isophorone diisocyanate, and 2-hydroxyethyl acrylate at a molar ratio of 1:1.2:2)
B-2: UC-203 (an esterification product of a maleic acid anhydride adduct of an isoprene polymerization product and 2-hydroxyethyl methacrylate; manufactured by Kuraray)
C-1: FA-512A (dicyclopentenyloxyethyl acrylate; manufactured by Hitachi Chemical Co., Ltd.)
C-2: S-1800A (isostearyl acrylate; manufactured by Shin-Nakamura Chemical Co., Ltd.)
C-3: LA (lauryl acrylate; manufactured by Osaka Organic Chemical Industry Ltd.)
D-1: Irgacure 184D (manufactured by BASF)
D-2: SpeedCure TPO (2,4,6-trimethylbenzoyldiphenylphosphine oxide; manufactured by LAMBSON)
E-1: LIR-390 (isoprene-butadiene copolymerization product; manufactured by Kuraray)
E-2: GI-2000 (hydrogenated polybutadiene terminated with hydroxy groups; manufactured by Nippon Soda Co., Ltd.)
E-3: Clearon M105 (aromatic modified hydrogenated terpene resin; manufactured by Yasuhara Chemical)
E-4: Tersorb MTPH (bornyl cyclohexanol; manufactured by Nippon Terpene Chemicals, Inc.)
X-1: CHDMMA (1,4-cyclohexane dimethanol monoacrylate; manufactured by Nippon Kasei Chemical Co., Ltd.)
X-2: HOB-A (2-hydroxybutyl acrylate; manufactured by Kyoeisha Chemical Co., Ltd.)
X-3: HOP (N) (2-hydroxypropyl methacrylate; manufactured by Kyoeisha Chemical Co., Ltd.)

The obtained compositions A to M of the present invention were used to perform the following evaluations.

### Whitening Resistance

### Experiment Examples 1 to 13

Two 1 mm-thick glass slides were prepared, and the compositions A to M were each applied to one of the glass slides in a thickness of 200 μm. The coated surface was then laminated to the other glass slide. The composition was irradiated with ultraviolet rays through the glass with a high-pressure mercury lamp (80 W/cm, ozone-less/equipped with an IR cut filter) in a cumulative light quantity of 4,000 mJ/cm². The resulting test piece was placed in an 80° C. 85% RH environment for 48 hours, and transferred to a 25° C. 45% RH environment. After 15 minutes, the test piece was visually inspected for the film state. The state of the cured film was also checked by visual inspection after 3 hours.

### Experiment Example 14

Composition K was applied to a 1 mm-thick glass slide in a thickness of 200 μm, and the coated surface was laminated to a detachable PET film. The composition was then irradiated with ultraviolet rays through the detachable PET film with a high-pressure mercury lamp (80 W/cm, ozone-less/equipped with an IR cut filter) in a cumulative light quantity of 4,000 mJ/cm². The resulting laminated structure was placed in an 80° C. 85% RH environment for 48 hours, and transferred to a 25° C. 45% RH environment. After 15 minutes, the laminated structure was visually inspected for the film state. The state of the cured film was also checked by visual inspection after 3 hours. The evaluation results are presented in Table 2.

Good: No film whitening

Acceptable: Whitening was observed after 15 minutes, but was not observable after 3 hours

Poor: Whitening was observed after 15 minutes and after 3 hours.

TABLE 2

| | Exper- | Exper- | Exper- | Exper- | Exper- | Exper- | Exper- | Exper- | Exper- | Exper- | Exper- | Exper- | Exper- | Exper- |
|---|---|---|---|---|---|---|---|---|---|---|---|---|---|---|
| | iment | iment | iment | iment | iment | iment | iment | iment | iment | iment | iment | iment | iment | iment |
| | Ex. 1 | Ex. 2 | Ex. 3 | Ex. 4 | Ex. 5 | Ex. 6 | Ex. 7 | Ex. 8 | Ex. 9 | Ex. 10 | Ex. 11 | Ex. 12 | Ex. 13 | Ex. 14 |
| Compo- | Compo- | Compo- | Compo- | Compo- | Compo- | Compo- | Compo- | Compo- | Compo- | Compo- | Compo- | Compo- | Compo- | Compo- |
| sition | sition A | sition B | sition C | sition D | sition E | sition F | sition G | sition H | sition I | sition J | sition K | sition L | sition M | sition K |
| used | | | | | | | | | | | | | | |
| Whitening | Accept- | Good | Good | Good | Good | Good | Good | Good | Poor | Poor | Poor | Poor | Good | Good |
| resistance | able | | | | | | | | | | | | | |
| evaluation | | | | | | | | | | | | | | |
| result | | | | | | | | | | | | | | |

### Bonding Strength 1

### Experiment Examples 15 to 27

A PET film and a 1 mm-thick glass plate were laminated to make the post-cure thickness of the compositions A to M of 200 μm. The composition was then irradiated with ultraviolet rays through the PET film with a high-pressure mercury lamp (80 W/cm, ozone-less/equipped with an IR cut filter) in a cumulative light quantity of 4,000 mJ/cm². The resulting laminated structure was measured for adhesion according to a JISZ0237 method. The glass plate in the laminated structure of the PET film and the 1 mm-thick glass plate was horizontally fixed with the PET film facing up, and the force required to peel the PET film in a vertical direction (90° upward) at the film end was measured. The evaluation results are presented in Table 3 along with the results of determination.

Good: Bonding strength was 6.0 N/cm or more

Acceptable: Bonding strength was 1.5 N/cm or more and less than 6.0 N/cm

Poor: Bonding strength was less than 1.5 N/cm

TABLE 3

| | Exper- | Exper- | Exper- | Exper- | Exper- | Exper- | Exper- | Exper- | Exper- | Exper- | Exper- | Exper- | Exper- |
|---|---|---|---|---|---|---|---|---|---|---|---|---|---|
| | iment | iment | iment | iment | iment | iment | iment | iment | iment | iment | iment | iment | iment |
| | Ex. 15 | Ex. 16 | Ex. 17 | Ex. 18 | Ex. 19 | Ex. 20 | Ex. 21 | Ex. 22 | Ex. 23 | Ex. 24 | Ex. 25 | Ex. 26 | Ex. 27 |
| Compo- | Compo- | Compo- | Compo- | Compo- | Compo- | Compo- | Compo- | Compo- | Compo- | Compo- | Compo- | Compo- | Compo- |
| sition | sition A | sition B | sition C | sition D | sition E | sition F | sition G | sition H | sition I | sition J | sition K | sition L | sition M |
| used | | | | | | | | | | | | | |
| Bonding | 8.0 | 8.0 | 9.0 | 8.5 | 7.5 | 3.6 | 5.0 | 1.6 | 6.3 | 8.5 | 8.0 | 8.0 | 0.5 |
| strength | | | | | | | | | | | | | |
| N/cm | | | | | | | | | | | | | |
| Deter- | Good | Good | Good | Good | Good | Accept- | Accept- | Accept- | Good | Good | Good | Good | Poor |
| mination | | | | | | able | able | able | | | | | |

### Cure Rate

### Experiment Examples 28 to 40

Two 1 mm-thick glass slides were prepared, and the compositions A to M were each applied to one of the glass slides in a thickness of 200 μm. The coated surface was then laminated to the other glass slide. The composition was irradiated with ultraviolet rays through the glass with a high-pressure mercury lamp (80 W/cm, ozone-less/equipped with an IR cut filter) in a cumulative light quantity of 100 mJ/cm². The composition state was checked after detaching the glass slides. The evaluation results are presented in Table 4.

Good: No fluidity

Poor: Curing was insufficient, and there was fluidity

TABLE 4

| | Exper- | Exper- | Exper- | Exper- | Exper- | Exper- | Exper- | Exper- | Exper- | Exper- | Exper- | Exper- | Exper- |
|---|---|---|---|---|---|---|---|---|---|---|---|---|---|
| | iment | iment | iment | iment | iment | iment | iment | iment | iment | iment | iment | iment | iment |
| | Ex. 28 | Ex. 29 | Ex. 30 | Ex. 31 | Ex. 32 | Ex. 33 | Ex. 34 | Ex. 35 | Ex. 36 | Ex. 37 | Ex. 38 | Ex. 39 | Ex. 40 |
| Compo- | Compo- | Compo- | Compo- | Compo- | Compo- | Compo- | Compo- | Compo- | Compo- | Compo- | Compo- | Compo- | Compo- |
| sition | sition A | sition B | sition C | sition D | sition E | sition F | sition G | sition H | sition I | sition J | sition K | sition L | sition M |
| used | | | | | | | | | | | | | |
| Deter- | Good | Good | Good | Good | Good | Good | Good | Good | Good | Good | Good | Poor | Poor |
| mination | | | | | | | | | | | | | |

### (Bonding Strength 2)

Glass laminated structures were obtained according to the following Experiment Examples 41 to 44.

### Experiment Example 41

Two glass plates, measuring 2 cm in width, 3.5 cm in length, and 1 mm in thickness were prepared. Composition C was applied to the center of one of the glass plates in a thickness of 200 μm, forming a circle having a diameter of 1 cm. The resulting coating layer was then irradiated with ultraviolet rays with an electrodeless UV lamp (D valve, manufactured by Heraeus Noblelight Fusion UV Inc.). Here, ultraviolet rays were applied in a cumulative light quantity of 100 mJ/cm² from the atmosphere side through a UV cut filter that blocks wavelengths of 320 nm or less to form a cured product layer having a cured portion and an uncured portion. The cured portion is a portion that is present on the lower side (the glass plate side) of the coating layer. The uncured portion is a portion that is present on the upper side (the atmosphere side) of the coating layer. The ultraviolet rays applied to composition C had a maximum illuminance ratio of 3 in a 200 to 320 nm wavelength range relative to the maximum illuminance of 100 taken in a wavelength range of 320 nm to 450 nm. The uncured portion on the upper side (the atmosphere side) of the coating layer was laminated to the other glass plate in a crossed fashion (crossed at 90° C. angle), and irradiated with ultraviolet rays through the laminated glass in a cumulative light quantity of 2,000 mJ/cm² to cure the resin cured product layer and obtain a laminated structure.

### Experiment Example 42

A cured product layer having a cured portion (a portion that is present on the lower side (the glass plate side) of the coating layer) and an uncured portion (a portion that is present on the upper side (the atmosphere side) of the coating layer) was formed in the same manner as in Experiment Example 41, except that the UV cut filter that blocks wavelengths of 320 nm or less was replaced with a 0.5 mm-thick glass plate. The ultraviolet rays applied to composition C had a maximum illuminance ratio of 21 in a 200 to 320 nm wavelength range relative to the maximum illuminance of 100 taken in a wavelength range of 320 nm to 450 am. The uncured portion on the upper side (the atmosphere side) of the coating layer was laminated to the other glass plate in a crossed fashion (crossed at 90° C. angle), and irradiated with ultraviolet rays through the laminated glass in a cumulative light quantity of 2,000 mJ/cm² to cure the resin cured product layer and obtain a laminated structure.

### Experiment Example 43

A cured product layer having a cured portion (a portion that is present on the lower side (the glass plate side) of the coating layer) and an uncured portion (a portion that is present on the upper side (the atmosphere side) of the coating layer) was formed in the same manner as in Experiment Example 41, except that the UV cut filter that blocks wavelengths of 320 nm or less was not used. The ultraviolet rays applied to composition C had a maximum illuminance ratio of 45 in a 200 to 320 nm wavelength range relative to the maximum illuminance of 100 taken in a wavelength range of 320 nm to 450 nm. The uncured portion on the upper side (the atmosphere side) of the coating layer was laminated to the other glass plate in a crossed fashion (crossed at 90° C. angle), and irradiated with ultraviolet rays through the laminated glass in a cumulative light quantity of 2,000 mJ/cm² to cure the resin cured product layer and obtain a laminated structure.

### Experiment Example 44

Composition C was applied onto a 100 μm-thick detachable PET film (100 mm×100 mm×100 μm) with an applicator in a thickness of 200 μm, and covered with a 25 μm-thick detachable PET film. Composition C was then cured to obtain a 200 μm-thick transparent adhesive sheet after irradiation of ultraviolet light, which was applied with an electrodeless UV lamp (D valve, manufactured by Heraeus Noblelight Fusion UV Inc.) in a cumulative light quantity of 2,000 mJ/cm². The 100 μm-thick detachable PET film was peeled off after cutting the adhesive sheet in a shape of a circle having a diameter of 1 cm. After detaching the detachable PET film, the transparent adhesive sheet was attached to the center of a glass plate measuring 2 cm in width, 3.5 cm in length, and 1 mm in thickness by moving a 1 kg-weight, 20 mm-wide rubber roller once in both directions. After peeling off the 25 μm-thick detachable PET film, a glass plate measuring 2 cm in width, 3.5 cm in length, and 1 mm in thickness was laminated to the transparent adhesive sheet in a crossed fashion (crossed at 90° C. angle) to obtain a laminated structure.

One of the glass plates of each laminated structure obtained in Experiment Examples 41 to 44 was vertically detached while the other glass plate was being fixed, and the state of the cured film after detaching the glass plate was checked by visual inspection. The evaluation results are presented in Table 5. Note that “cohesive detachment” means that separation occurred in the resin cured product itself, rather than at the interface between the substrate and the resin cured product, whereas “interfacial detachment” means that peeling occurred at the interface between the substrate and the resin cured product.

Good: Cohesive detachment only

Acceptable: Cohesive detachment and interfacial detachment occurred at the same time

Poor: Interfacial detachment only

TABLE 5

| | Experiment | Experiment | Experiment | Experiment |
|---|---|---|---|---|
| | Ex. 41 | Ex. 42 | Ex. 43 | Ex. 44 |
| Determination | Good | Good | Acceptable | Poor |

It can be seen from these results that the ultraviolet-curable adhesive compositions of the present invention, and the producing method of the present invention offer desirable curability, and high whitening resistance. The adhesion for the base material is also strong, and remains high even when the composition is directly applied to the base material, and laminated to the other base material after being cured by irradiation of ultraviolet light.

The obtained compositions A to H of the present invention were used to perform the following evaluations.

### (Cure Shrinkage Rate)

Two 1 mm-thick glass slides coated with a fluorine-based release agent were prepared, and the composition was applied to the release agent-coated surface of one of the glass slides in a thickness of 200 μm. The two glass slides were then laminated to each other with the release agent-coated surfaces facing each other. The resin composition was irradiated with ultraviolet rays through the glass with a high-pressure mercury lamp (80 W/cm, ozone-less) in a cumulative light quantity of 2,000 mJ/cm². The two glass slides were then detached from each other to produce a cured product for film specific gravity measurement. The specific gravity (DS) of the cured product was measured according to the JIS K7112 B method. The liquid specific gravity (DL) of the resin composition was measured at 25° C. The cure shrinkage rate, calculated from the DS and DL measurement results according to the following equation, was less than 3.0%.

Cure shrinkage rate (%)=(DS−DL)+DS×100

### (Heat-Resistant and Moisture-Resistant Bondability)

A 0.8 mm-thick glass slide, and a 0.8 mm-thick acrylic plate were prepared.

The obtained composition was applied to one of the glass slide and the acrylic plate in a thickness of 200 μm, and the coated surface was laminated to the other. The resin composition was irradiated with ultraviolet rays through the glass with a high-pressure mercury lamp (80 W/cm, ozone-less) in a cumulative light quantity of 2,000 mJ/cm² to cure the resin composition and produce a sample for bondability evaluation. The sample was left unattended in an 85° C., 85% RH environment for 250 hours. The evaluation sample was visually inspected to check whether the resin cured product detached from the glass slide or the acrylic plate. There was, however, no detachment.

### (Flexibility)

The obtained composition was sufficiently cured, and measured for durometer E hardness according to a JIS K7215 method, using a durometer hardness meter (type E), and the flexibility was evaluated. More specifically, the ultraviolet-curable resin composition was poured into a cylindrical mold until the thickness was 1 cm, and was sufficiently cured by irradiation of ultraviolet light. The hardness of the cured product obtained was measured with a durometer hardness meter (type E). As a result, a measurement value was less than 10, and the flexibility was desirable.

### (Transparency)

Two 1 mm-thick glass slides coated with a fluorine-based release agent were prepared, and the composition obtained was applied to the release agent-coated surface of one of the glass slides in a thickness that makes the composition 200 μm-thick after curing. The two glass slides were then laminated to each other with the release agent-coated surfaces facing each other. The resin composition was cured by being irradiated with ultraviolet rays through the glass with a high-pressure mercury lamp (80 W/cm, ozone-less) in a cumulative light quantity of 2,000 mJ/cm². The two glass slides were then detached from each other to produce a cured product for transparency measurement. The transparency of the cured product obtained was measured by measuring transmittance in a 400 to 800 nm, and 400 to 450 nm wavelength region, using a spectrophotometer (U-3310, Hitachi High-Technologies). As a result, the transmittance was 90% or more both in the 400 to 800 am wavelength region, and in the 400 to 450 nm wavelength region.

### (Resin Curability Under Light-Shielding Portion)

The composition was applied to the display surface of a 3.5-inch area liquid crystal display unit, and to the light-shielding portion side of a transparent substrate that had a light-shielding portion (5-mm wide) at the peripheries. The composition was applied to each substrate in a thickness of 125 μm. The coating layer so obtained was irradiated with ultraviolet rays through a UV cut filter that blocks wavelengths of 320 nm or less, using an electrodeless UV lamp (D valve; manufactured by Heraeus Noble Light Fusion UV Inc.). Here, UV light was applied from the atmosphere side in a cumulative light quantity of 100 mJ/cm² to form a cured product layer having a cured portion and an atmosphere-side uncured portion. The ultraviolet rays applied to the composition had a maximum illuminance ratio of 3 in a 200 to 320 nm wavelength range relative to the maximum illuminance of 100 taken in a wavelength range of 320 nm to 450 nm. The liquid crystal display unit, and the transparent substrate having a light-shielding portion was then laminated to each other with the uncured portions facing each other. Finally, the resin cured product layer was cured by applying ultraviolet rays in a cumulative light quantity of 2,000 mJ/cm² to produce an optical member. Here, UV light was applied from the glass substrate side where the light-shielding portion was formed, using an ultrahigh-pressure mercury lamp (TOSCURE752, manufactured by Harison Toshiba Lighting Corporation). After removing the transparent substrate from the optical member obtained, the resin cured product layer at the light-shielding portion was rinsed with heptane, and checked for cured state. There was no trace of the uncured resin composition having been removed, and the resin at the light-shielding portion was sufficiently cured.

While the present invention has been described in detail and with reference to certain embodiments of the invention, it will be apparent to a skilled person that various changes and modifications may be made thereto without departing from the spirit and scope of the present invention.

This patent application is based on Japanese patent application No. 2014-23116, filed on Feb. 10, 2014, which is hereby incorporated by reference in its entirety. All references cited herein are hereby incorporated in its entirety.

### INDUSTRIAL APPLICABILITY

The ultraviolet-curable adhesive composition of the present invention is preferred for use in the production of a touch panel.

### REFERENCE SIGNS LIST

1 Liquid crystal display unit
2 Transparent substrate having a light-shielding portion
3 Transparent substrate
4 Light-shielding portion
5 Ultraviolet-curable resin composition (ultraviolet-curable adhesive composition)
6 Cured product layer having an uncured portion
7 Resin cured product layer
8 Ultraviolet rays

1. An ultraviolet-curable adhesive composition for touch panels, the composition being a resin composition for use in the lamination of at least two optical base materials, and comprising a monofunctional acrylate (A) represented by the following formula (1), a photopolymerizable oligomer (B), a photopolymerizable monomer (C) other than (A), and a photopolymerization initiator (D), 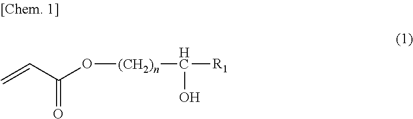
wherein R₁ represents a hydrogen atom or CH₃, and n represents an integer of 1 to 3.

2. The ultraviolet-curable adhesive composition for touch panels according to claim 1, wherein the (A) component is contained in the ultraviolet curable composition in an amount of 2 mass % or more.

3. The ultraviolet-curable adhesive composition for touch panels according to claim 1, wherein the photopolymerizable oligomer (B) is a urethane (meth)acrylate.

4. The ultraviolet-curable adhesive composition for touch panels according to claim 3, wherein the photopolymerizable oligomer (B) is a urethane (meth)acrylate having at least one skeleton selected from the group consisting of polypropylene, polybutadiene, hydrogenated polybutadiene, polyisoprene, and hydrogenated polyisoprene.

5. The ultraviolet-curable adhesive composition for touch panels according to claim 1, wherein the monofunctional acrylate (A) is represented by the following formula (2), 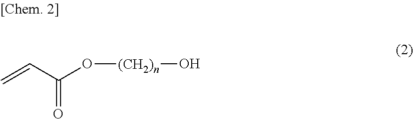
wherein n represents an integer of 2 to 4.

6. The ultraviolet-curable adhesive composition for touch panels according to claim 1, wherein the (A) component is 4-hydroxybutyl acrylate.

7. The ultraviolet-curable adhesive composition for touch panels according to claim 1, which further comprises a softening component (E).

8. The ultraviolet-curable adhesive composition for touch panels according to claim 7, which contains a hydroxyl group-containing polymer, and/or a liquid terpene-based resin as the softening component (E).

9. The ultraviolet-curable adhesive composition for touch panels according to claim 1, which comprises a monofunctional acrylate represented by the following formula (3) as the (C) component,
[Chem. 3]
X—O—R₂ (3)
wherein X represents an acryloyl group, and R₂ represents an alkyl group of 10 to 20 carbon atoms.

10. The ultraviolet-curable adhesive composition for touch panels according to claim 1, which comprises a monofunctional acrylate represented by the following formula (4) as the (C) component,
[Chem. 4]
X—O—R₃ (4)
wherein X represents an acryloyl group, and R₃ represents an alkyl group of 12 to 18 carbon atoms.

11. The ultraviolet-curable adhesive composition for touch panels according to claim 1, which comprises isostearyl acrylate as the (C) component.

12. A method for producing an optical member that includes at least two optical base materials that are laminated to each other,
the method comprising the steps of:
1) applying the ultraviolet-curable adhesive composition for touch panels of claim 1 to at least one optical base material to form a coating layer, and irradiating the coating layer with ultraviolet light to obtain an optical base material having a cured product layer; and
2) laminating another optical base material, or the cured product layer of another optical base material obtained in the step 1) to the cured product layer of the optical base material obtained in the step 1).

13. The method according to claim 12, wherein the cured product layer obtained in the step 1) includes a cured portion and an uncured portion, the cured portion being a portion that is present on the optical base material side, and the uncured portion being a portion that is present opposite the optical base material side.

14. The method according to claim 13, further comprising the step 3) of curing the cured product layer by applying ultraviolet light to the cured product layer having the uncured portion in the laminated optical base material, the step 3) being performed after the steps 1) and 2).

15. The method according to claim 12, wherein the ultraviolet light applied to the ultraviolet-curable adhesive composition in the step 1) has a maximum illuminance ratio of 30 or less in a 200 to 320 nm wavelength range relative to the maximum illuminance of 100 taken in a wavelength range of 320 nm to 450 nm.

16. The method according to claim 12, wherein the ultraviolet light applied to the ultraviolet-curable adhesive composition in the step 1) has a maximum illuminance ratio of 10 or less in a 200 to 320 nm wavelength range relative to the maximum illuminance of 100 taken in a wavelength range of 320 nm to 450 nm.

17. A cured product obtained by irradiating the ultraviolet-curable adhesive of claim 1 with an active energy ray.

18. A touch panel using the ultraviolet-curable adhesive of claim 1.
